(19) United States
(12) Patent Application Publication
(10) Pub. No.: US 2026/0191150 A1
(43) Pub. Date: Jul. 9, 2026

(54) VERTICAL PLANTER ASSEMBLY FOR GREENING WALL BODY

(71) Applicant: CHOROK-IN. CO., LTD., Dangjin-si, Chungcheongnam-do (KR)

(72) Inventor: Tae Pyung JEON, Dangjin-si, Chungcheongnam-do (KR)

(21) Appl. No.: 19/134,207

(22) PCT Filed: Sep. 22, 2023
(86) PCT No.: PCT/KR2023/014463

§ 371 Date: May 29, 2025

(30) Foreign Application Priority Data
Dec. 2, 2022 (KR) 10-2022-0166357

(51) Int. Cl. A01G 9/02; A01G 27/00

(52) U.S. Cl. CPC A01G 9/023; A01G 9/025; A01G 27/006

(57) ABSTRACT

The present inventive concept relates to a vertical planter assembly for greening a wall body and includes: a vertical guide; multiple cultivation housings which have exposed front surfaces to provide a front landscape effect and are stacked on and coupled to each other along the longitudinal direction of the vertical guide; and a planter pot mounted to each of the cultivation housings by means of a cover part coupled to an open front surface of each of the cultivation housings. The vertical guides can be installed along a general wall body and the surface of a circular column in a state of being fixed in parallel to each other, and can also be arranged in a concentric circle structure, so that the guides can be independently installed regardless of place.

### TECHNICAL FIELD

The present inventive concept relates to a vertical planter assembly for greening a wall body, which can be installed along a general wall surface and a circular column surface and can be installed regardless of location by being arranged independently in a concentric structure, and more specifically, a vertical planter assembly for greening a wall body, in which multiple cultivation housings are stacked and constructed along a vertical guide by their own weight to allow for very easy installation, which allows water to be automatically supplied to the cultivation housing disposed at the bottommost layer through an overflow opening when water is supplied to the cultivation housing disposed at the topmost layer, and in which an air circulation space is provided between the vertical guide and the cultivation housings to uniformly supply humid air by convection to the multiple cultivation housings, thereby enabling more convenient maintenance of plants planted in the planter pots.

### BACKGROUND ART

In general, the photosynthetic action of plants consumes carbon dioxide exhaled by humans and produces oxygen beneficial to the human body during the respiratory process, and thus is known to be advantageous to human health.

In places with little greenery, such as apartments or office buildings, plant pots are arranged and used to grow plants in order to obtain such effects.

The air purification performance of plant pots in which plants are planted is related to the respiration or photosynthesis of the plant leaves and the soil. Soil which contains pores and organic matters helps the plant grow and facilitates root settlement, and the soil with pores acts as a kind of filter, thereby filtering out foreign substances contained in air or water.

Recently, as air quality has deteriorated due to fine dust, various methods have been proposed to reduce fine dust. However, air purification devices or equipment currently in use are generally developed exclusively for the purpose of air purification.

Pots used for growing plants are mainly used for ornamental purposes and are used for air purification through the plant's self-purification function, but there have been insufficient proposals utilizing the roots of plants with high air purification performance.

Furthermore, a conventional patent invention entitled “Paper plant pot assembly” (Korean Patent No. 10-2098487) has been disclosed.

However, the “Paper plant pot assembly” is non-permanent and has a short lifespan and a complex structure.

Furthermore, the conventional “Paper plant pot assembly” has a structure in which water must be frequently supplied to cultivate plants, thereby causing difficulties in maintenance.

### DISCLOSURE

### Technical Problem

Accordingly, the present inventive concept has been made in view of the above-mentioned problems occurring in the related art, and it is a first objective of the present inventive concept to provide a vertical planter assembly for greening a wall body, which can be installed along a general wall surface and a circular column surface and can be installed regardless of location by being arranged independently in a concentric structure.

It is a second objective of the present inventive concept to provide a vertical planter assembly for greening a wall body, in which multiple cultivation housings are stacked and constructed along a vertical guide by their own weight to allow for very easy installation, which allows water to be automatically supplied to the cultivation housing disposed at the bottommost layer through an overflow opening when water is supplied to the cultivation housing disposed at the topmost layer, and in which an air circulation space is provided between the vertical guide and the cultivation housings to uniformly supply humid air by convection to the multiple cultivation housings, thereby enabling more convenient maintenance of plants planted in the planter pots.

### Technical Solution

To accomplish the above-mentioned objects, in a first embodiment of the present inventive concept, there is provided a vertical planter assembly for greening a wall body including: a vertical guide; multiple cultivation housings which have open front surfaces to provide a front landscape effect and are stacked on and coupled to each other in the longitudinal direction of the vertical guide; and planter pots, each of which is mounted to each of the cultivation housings by means of a cover part coupled to the open front surface of the cultivation housing, wherein the vertical guides can be installed along a general wall body and the surface of a circular column in a state of being fixed in parallel to each other, and can be arranged in a concentric circle structure, so that the guides can be arranged in a concentric structure for independent installation regardless of location.

In a second embodiment of the present inventive concept, the planter pot has a lattice structure such that roots of a plant are exposed, an air circulation space is formed between the vertical guide and the cultivation housing, and the cultivation housing further includes a through-hole for circulating air with the air circulation space, and an overflow opening for allowing water to drop to the cultivation housing arranged below.

In a third embodiment of the present inventive concept, the vertical guide has a square C-shaped cross section including a rear wall and side walls bent from both sides of the rear wall, and the vertical guide further includes a plurality of rail portions protruding vertically from an inner surface of the rear wall and guide grooves protruding vertically from inner surfaces of the respective side walls, such that the air circulation space is formed between the vertical guide and the cultivation housing.

In a fourth embodiment of the present inventive concept, the cultivation housing further includes a plurality of rail grooves formed on a rear surface thereof to be slidably coupled to the rail portions of the vertical guide, and protrusion lines formed on both side surfaces thereof to be slidably coupled to the guide grooves of the vertical guide.

In a fifth embodiment of the present inventive concept, the cultivation housing is open at a top portion and the front surface thereof and further includes an eave part inclined upward at the open front surface, and the cover part includes: a first cover plate coupled to the open front surface of the cultivation housing, and a second cover plate bent downward and inclined from the first cover plate so as to cover the eave part, wherein the first cover plate includes a mounting hole in which the planter pot is mounted and a plurality of guide bars configured to guide the planter pot at an inclination angle.

In a sixth embodiment of the present inventive concept, the cultivation housing further includes a nonwoven fabric fixed in a hanging state at a lower front portion thereof, and the nonwoven fabric extends to the bottom surface of the cultivation housing arranged below and absorbs moisture by the capillary action to continuously supply the moisture to roots of a plant planted in the planter pot of the cultivation housing arranged below.

In a seventh embodiment of the present inventive concept, the first cover plate of the cover part is one of a trapezoidal shape with an expanded lower width or a rectangular shape.

In an eighth embodiment of the present inventive concept, the vertical guide further includes a circular connection band configured to interconnect the vertical guides arranged in parallel to be arranged independently in a concentric structure.

### Advantageous Effect

According to embodiments of the present inventive concept, the vertical planter assembly for greening a wall body is very simple since having the structure including only four components (the vertical guide, the cultivation housing, the cover part, and the planter pot), and is very convenient in installation since the cultivation housings are slidably coupled to the vertical guide and automatically stacked by their own weight.

Moreover, the vertical planter assembly for greening a wall body allows for not only greening general wall surfaces and circular columns, but also installation in the concentric structure without walls or columns, thereby providing installation without spatial constraints.

Additionally, the vertical planter assembly for greening a wall body allows water to be automatically supplied to the cultivation housing disposed at the bottommost layer through an overflow opening when water is supplied to the cultivation housing disposed at the topmost layer, thereby allowing for easy plant management.

In addition, the vertical planter assembly for greening a wall body includes an air circulation space provided between the vertical guide and the cultivation housings to uniformly supply humid air by convection to the multiple cultivation housings, thereby enabling more convenient maintenance of plants planted in the planter pots.

### DESCRIPTION OF DRAWINGS

FIGS. 1 to 3 are perspective views illustrating a state in which a vertical planter assembly for greening a wall body according to the present inventive concept is installed.

FIG. 4 is a perspective view of the vertical planter assembly for greening a wall body according to the present inventive concept.

FIG. 5 is an exploded perspective view of FIG. 4.

FIGS. 6 and 7 are perspective views of a cultivation housing in FIG. 5.

FIG. 8 is a rear perspective view of a cover part in FIG. 5.

FIG. 9 is a perspective view illustrating an opened state of a planter pot in FIG. 5.

FIGS. 10 and 11 are cross-sectional views taken along the X-axis and Y-axis of FIG. 4.

### MODE FOR INVENTION

The objects, features, and advantageous of the present inventive concept will be described in detail through the following preferable exemplary embodiments with reference to the accompany drawings. As those skilled in the art would realize, the described embodiments may be modified in various different ways, all without departing from the spirit or scope of the present inventive concept.

On the contrary, exemplary embodiments introduced herein are provided to make disclosed contents thorough and complete and to sufficiently transfer the spirit of the present inventive concept to those skilled in the art.

The exemplary embodiments described and exemplarily illustrated herein include complementary exemplary embodiments.

In the specification, the terms of a singular form may include a plural form unless otherwise specified. It should be also understood that the terms of ‘comprise’ or ‘comprising’ in the specification are used to mean that there is no intent to exclude existence or addition of other components besides components described in the specification.

Hereinafter, the present inventive concept will be described in detail with reference to the drawings. In describing specific embodiments below, various specific details are provided to offer a clearer understanding of the inventive concept. However, it will be apparent to those skilled in the art that the inventive concept may be practiced without such specific details. In some cases, well-known structures or processes that are not directly relevant to the inventive concept are not described in detail so as to avoid unnecessary confusion in understanding the inventive concept.

Hereinafter, a vertical planter assembly for greening a wall body according to the present inventive concept will be described in more detail with reference to the accompanying drawings.

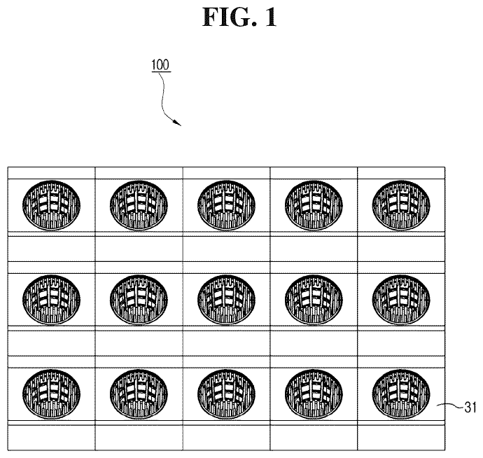

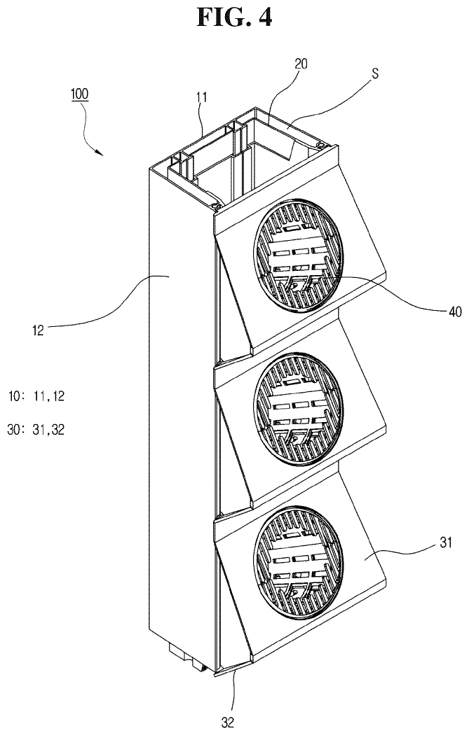

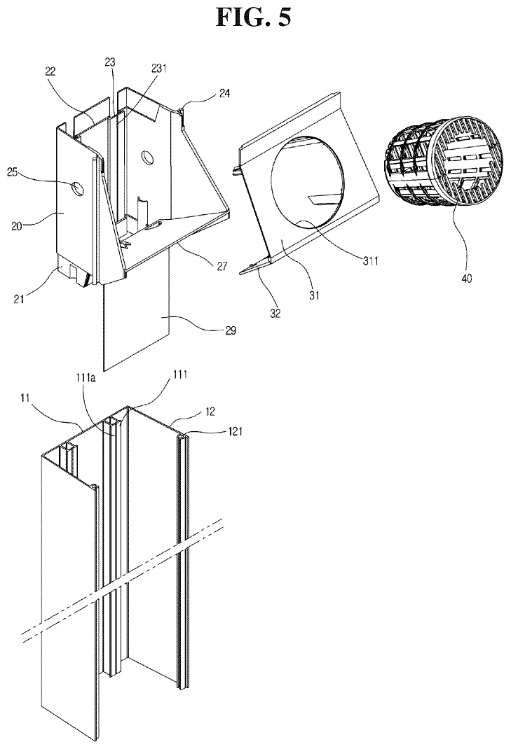

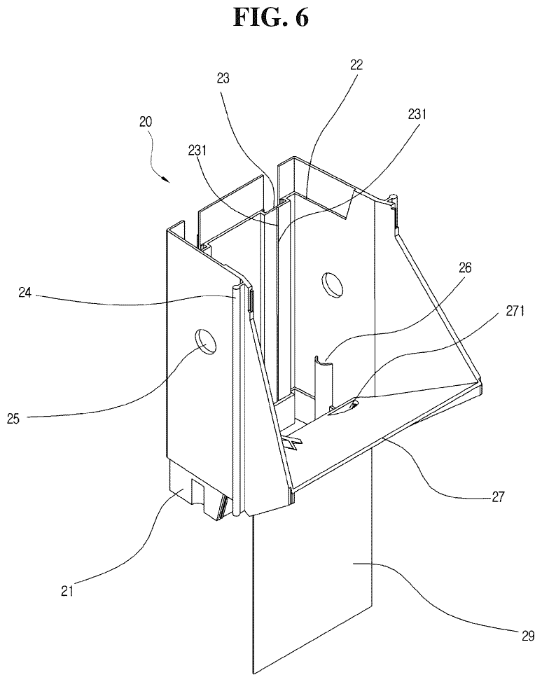

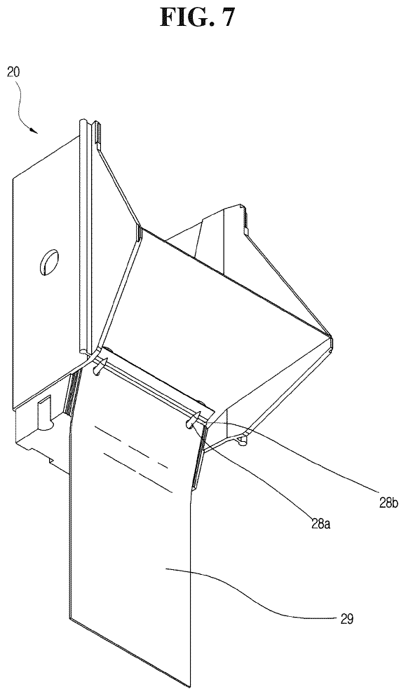

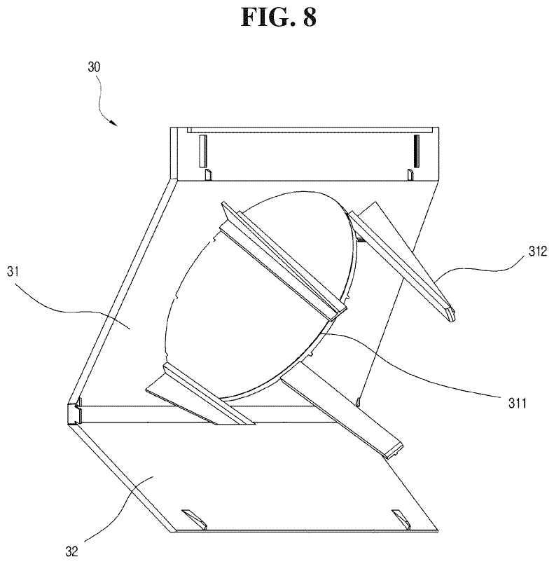

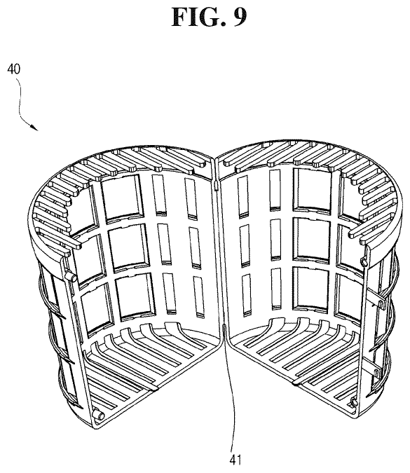

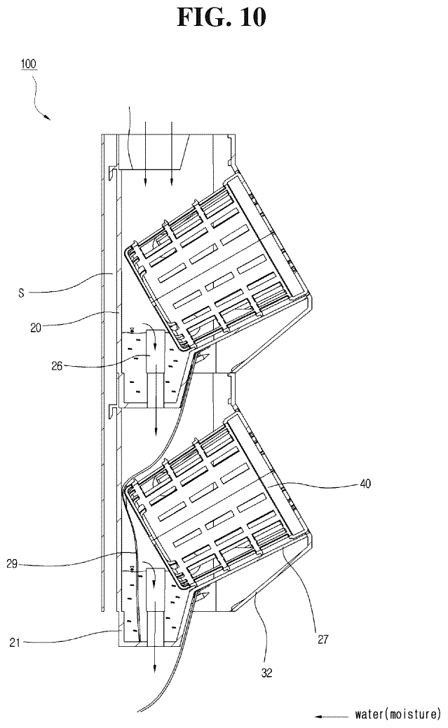

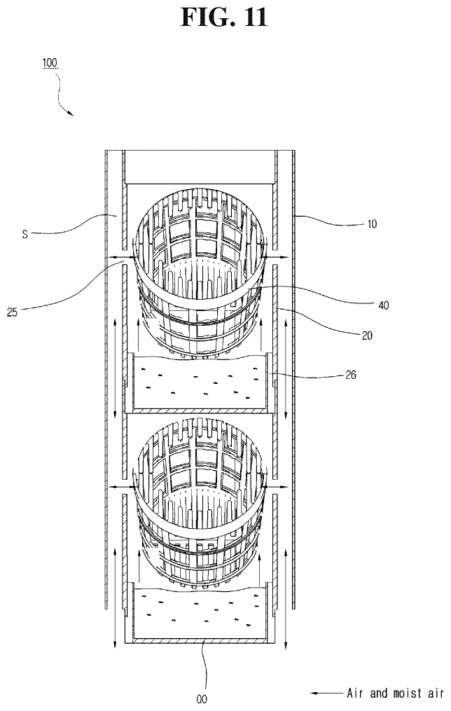

FIGS. 1 to 3 are perspective views illustrating a state in which a vertical planter assembly for greening a wall body according to the present inventive concept is installed, FIG. 4 is a perspective view of the vertical planter assembly for greening a wall body according to the present inventive concept, FIG. 5 is an exploded perspective view of FIG. 4, FIGS. 6 and 7 are perspective views of a cultivation housing in FIG. 5, FIG. 8 is a rear perspective view of a cover part in FIG. 5, FIG. 9 is a perspective view illustrating an opened state of a planter pot in FIG. 5, and FIGS. 10 and 11 are cross-sectional views taken along the X-axis and Y-axis of FIG. 4.

As illustrated in FIGS. 1 to 11, the present inventive concept relates to a vertical planter assembly 100 for greening a wall body, which can be installed along a general wall surface and a circular column surface and can be installed regardless of location by being arranged independently in a concentric structure.

Moreover, the vertical planter assembly 100 for greening a wall body includes multiple cultivation housings stacked and constructed along a vertical guide by their own weight to allow for very easy installation, allows water to be automatically supplied to the cultivation housing disposed at the bottommost layer through an overflow opening when water is supplied to the cultivation housing disposed at the topmost layer, and includes an air circulation space provided between the vertical guide and the cultivation housings to uniformly supply humid air by convection to the multiple cultivation housings, thereby enabling more convenient maintenance of plants planted in the planter pots.

As illustrated in FIG. 5, the vertical planter assembly 100 according to the present inventive concept mainly includes four components: a vertical guide 10, cultivation housings 20, cover parts 30, and planter pots 40.

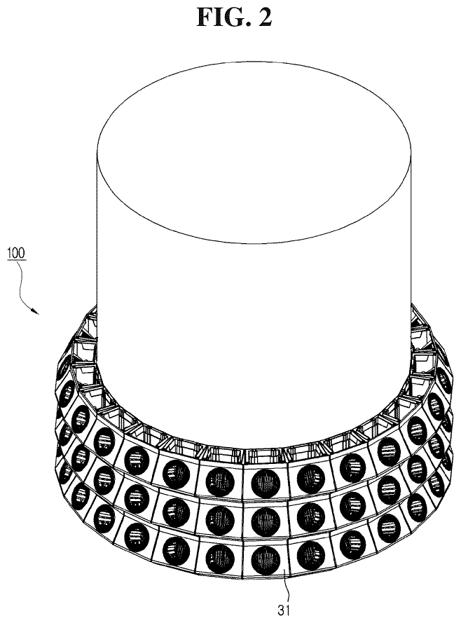

The vertical guides 10 are arranged and fixed in parallel with each other in a vertical direction. The vertical guides 10 can be arranged along the general wall surface as illustrated in FIG. 1, and along the surface of a circular column as illustrated in FIG. 2, thus enhancing aesthetics.

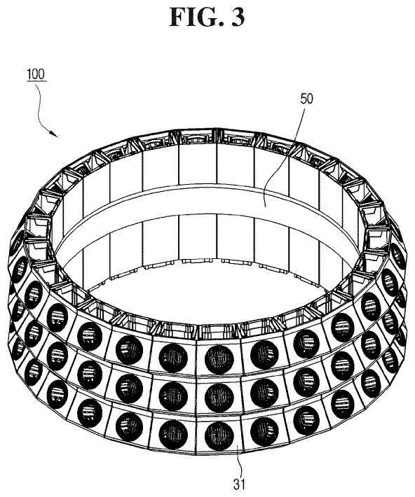

Moreover, as illustrated in FIG. 3, the vertical guide 10 may also be arranged independently in a concentric structure without a circular column, thus enabling installation regardless of location. In this case, a circular connection band 50 may be additionally attached to interconnect each vertical guide 10.

Furthermore, as illustrated in FIG. 5, the vertical guide 10 has a square “C” shaped structure in cross section, including a rear wall 11 and side walls 12 bent from both sides of the rear wall 11.

Additionally, in order to allow the cultivation housings 20 to be slidably coupled in the vertical direction, the vertical guide 10 includes a plurality of rail portions 111 protruding vertically and formed on the inner surface of the rear wall 11, and guide grooves 121 protruding vertically and formed on the inner surfaces of the respective side walls 12.

Such a vertical guide 10 forms an air circulation space S formed between the vertical guide and cultivation housings 20 through the rail portions 111 and the guide grooves 121 protruding inward and the cultivation housings 20.

In addition, the rail portions 111 of the vertical guide 10 may further include piece coupling lines 111a having a reduced thickness. When pieces are coupled to the piece coupling lines 111a, the vertical guide 10 can be easily fixed to a wall or column.

As illustrated in FIGS. 6 and 7, each cultivation housing 20 has an open front surface to provide a landscape effect forward and to be stacked and coupled on each other in the longitudinal direction of the vertical guide 10.

To allow stacking on each other, the cultivation housing 20 may include an insertion portion 21 with a relatively smaller size formed at a lower portion thereof, and a stepped portion 22 formed at an upper portion thereof to limit the insertion depth of the insertion portion 21.

Here, the cultivation housing 20 is open at the top and front sides, and the insertion portion 21 serves as a reservoir to store water.

Moreover, on the rear side of the cultivation housing 20, a plurality of rail grooves 23 are formed to be slidably coupled with the rail portions 111 of the vertical guide 10, and on both sides, protrusion lines 24 are formed to be slidably coupled with the guide grooves 121 of the vertical guide 10.

In this instance, the rail grooves 23 may also be provided with piece coupling lines 231 corresponding to the piece coupling lines formed in the rail portions 111.

Furthermore, as illustrated in FIG. 10, the cultivation housing 20 is further provided with a through-hole 25 through which air is circulated with the air circulation space S, and an overflow opening 26 for overflowing water when reaching a predetermined water level. Accordingly, when water is supplied to the cultivation housing 20 positioned at the topmost layer, the water can be automatically supplied to the cultivation housing 20 at the bottommost layer through the overflow opening 26.

Here, the through-hole 25 allows air and humid air to circulate through the air circulation space S to supply air together with moisture to the roots of the plant, thereby promoting plant growth.

Meanwhile, as illustrated in FIG. 5, the planter pot 40 is mounted to the cultivation housing 20 via a cover part 30 coupled to the front of the cultivation housing 20. The planter pot 40 may be formed in a lattice structure to expose the roots of the planted plant so that the roots of the planted plant can easily come into contact with moisture, water, and air.

As illustrated in FIG. 9, the planter pot 40 may be configured to be openable and closable via a hinge part 41, thus allowing for more convenient planting.

Moreover, the cultivation housing 20 is further formed with an eave part 27 inclined upward at the open front surface.

The eave part 27 supports the cover part 30 to facilitate the coupling and enables the cover part 30 and the planter pot 40 to be installed at an inclined angle.

More specifically, the eave part 27 may have an upward inclination angle ranging from 30° to 50° relative to the horizontality, such that the cover part 30 and the planter pot 40 are installed with an upward inclination within the range of 30° to 50°.

Here, when the planter pot 40 is installed at the inclination angle of 30° to 50°, it becomes advantageous in preventing the planter pot 40 from falling and the plant from sagging due to gravity. Preferably, an angle around 45° is optimal for preventing both falling of the planter pot 40 and sagging of the plant.

Furthermore, as illustrated in FIG. 8, the cover part 30 may include a first cover plate 31 coupled to the open front surface of the cultivation housing 20, and a second cover plate 32 bent downwardly and inclined from the first cover plate 31 to cover the eave part 27.

In this instance, the first cover plate 31 may further include a mounting hole 311 for mounting the planter pot 40 and a plurality of guide bars 312 to inclinedly guide the planter pot 40 into the mounting hole 311.

Here, the guide bars 312 serve to maintain the inclination angle of the planter pot 40 inserted into the mounting hole 311.

Additionally, the first cover plate 31 may have one of a trapezoidal shape with an expanded lower width and a rectangular shape.

Here, the first cover plate 31 which is trapezoidal may be used when the vertical guide 10 is installed in a concentric structure or on a column, as illustrated in FIGS. 2 and 3. The first cover plate 31 which is rectangular may be used when the vertical guide 10 is installed on a general wall, as illustrated in FIG. 1.

The above configuration is intended to prevent a gap from being generated between the adjacent cover parts 30 arranged in parallel.

Meanwhile, the cultivation housing 20 may further include a nonwoven fabric 29 formed at the lower front portion thereof to be fixed in a hanging state.

In this case, as illustrated in FIG. 7, the cultivation housing 20 may further include a plurality of fixing pins 28a protruding for fixing the nonwoven fabric 29, and a pressing rod 28b for pressing the nonwoven fabric 29 fixed to the fixing pins 28a.

Here, the fixing pins 28a temporarily fix the nonwoven fabric 29 in the hanging state by penetrating the nonwoven fabric, and the pressing rod 28b is press-fitted between the fixing pins 28a and the cultivation housing 20 to prevent the nonwoven fabric 29 from being detached.

Moreover, the nonwoven fabric 29 extends down to the bottom surface of the cultivation housing 20 arranged below, thereby absorbing moisture through the capillary action.

Furthermore, the hanging nonwoven fabric 29 is brought into contact with the planter pot 40 of the cultivation housing 20 positioned below, thereby continuously supplying moisture to the roots of the plants planted in the planter pot 40.

Meanwhile, a plurality of absorption holes 271 may be formed at the lower portion of the eave part 27 to supply water to the nonwoven fabric 29 when the water in the cultivation housing 20 reaches a certain level.

In this case, it is preferable that the overflow opening 26 formed in the cultivation housing 20 is positioned at a relatively higher level than the absorption holes 271.

Hereinafter, the installation procedure of the vertical planter assembly for greening a wall body according to the present inventive concept will be briefly described.

The vertical guide 10 is fixed by coupling the pieces to the piece coupling lines 111a.

In this state, the cultivation housing 20 is slidably coupled from the top of the vertical guide 10.

Then, the cultivation housing 20 descends along the vertical guide 10 by its self-weight, thus allowing multiple cultivation housings 20 to be easily stacked and coupled.

In this instance, since the insertion portion 21 and the stepped portion 22 of the stacked cultivation housings 20 are mutually coupled, the multiple stacked cultivation housings 20 can be interconnected.

Thereafter, each cover part 30 is coupled to each cultivation housing 20, and finally, the planter pot 40 in which plant is planted is mounted into the mounting hole 311 formed in the first cover plate 30, thereby completing the installation more easily.

The vertical planter assembly 100 for greening a wall body is very simple since having the structure including only four components (the vertical guide, the cultivation housing, the cover part, and the planter pot), and is very convenient in installation since the cultivation housings are slidably coupled to the vertical guide 10 and automatically stacked by their own weight.

Moreover, the vertical planter assembly for greening a wall body allows for not only greening general wall surfaces and circular columns, but also installation in the concentric structure without walls or columns, thereby providing installation without spatial constraints.

Hereinafter, the functions of the vertical planter assembly for greening a wall body according to the present inventive concept will be briefly described.

As illustrated in FIG. 10, water is supplied into the cultivation housing 20 disposed at the topmost layer of the vertical guide 10.

The water supplied to the topmost cultivation housing 20 is discharged through the overflow opening 26 when the water reaches a certain level.

The discharged water drops and is supplied to the cultivation housing 20 disposed below, making it possible to easily supply water to even the bottommost cultivation housing 20.

Additionally, the water supplied to the cultivation housing 20 is absorbed by the capillary action of the nonwoven fabric 29, and the absorbed moisture is supplied to the roots of the plants planted in the planter pots 40 over a long period of time.

At this time, as illustrated in FIG. 11, some of the humid air generated due to the evaporation of moisture in each cultivation housing 20 is supplied to the roots of the plants to aid the growth of the plants, and some of the humid air is circulated with air through the through-holes 25.

Since the circulated air and humid air are circulated into the air circulation space S by upward convection, moisture can be continuously supplied even to cultivation housings 20 in which water has dried up. Accordingly, the vertical planter assembly for greening a wall body according to the present inventive concept provides great convenience for plant maintenance.

Although not mentioned in the present inventive concept, a water vessel may be installed below the cultivation housing disposed at the bottommost layer of the vertical guide, and a sealing plate may be coupled to the cultivation housing disposed at the topmost layer to prevent evaporation of moisture.

The configurations described in exemplary embodiments and the accompanying drawings of the present inventive concept do not represent all of the technical spirits of the present inventive concept, but are merely most preferable embodiments. Therefore, the present inventive concept should be construed as including all the changes, equivalents, and substitutions included in the spirit and scope of the present inventive concept at the time of filing this application.

1. A vertical planter assembly for greening a wall body comprising:
a vertical guide (10);
multiple cultivation housings (20) which have open front surfaces to provide a front landscape effect and are stacked on and coupled to each other in the longitudinal direction of the vertical guide (10); and
planter pots (40), each of which is mounted to each of the cultivation housings by means of a cover part (30) coupled to the open front surface of the cultivation housing (20),
wherein the vertical guides (10) can be installed along a general wall body and the surface of a circular column in a state of being fixed in parallel to each other, and can be arranged in a concentric circle structure, so that the guides can be arranged in a concentric structure for independent installation regardless of location.

2. The vertical planter assembly according to claim 1, wherein the planter pot (40) has a lattice structure such that roots of a plant are exposed,
wherein an air circulation space (S) is formed between the vertical guide (10) and the cultivation housing (20), and
wherein the cultivation housing (20) further includes a through-hole (25) for circulating air with the air circulation space (S), and an overflow opening (26) for allowing water to drop to the cultivation housing (20) arranged below.

3. The vertical planter assembly according to claim 2, wherein the vertical guide (10) has a square C-shaped cross section including a rear wall (11) and side walls (12) bent from both sides of the rear wall (11), and
wherein the vertical guide (10) further includes a plurality of rail portions (111) protruding vertically from an inner surface of the rear wall (11) and guide grooves (121) protruding vertically from inner surfaces of the respective side walls (12), such that the air circulation space (S) is formed between the vertical guide (10) and the cultivation housing (20).

4. The vertical planter assembly according to claim 3, wherein the cultivation housing further includes a plurality of rail grooves (23) formed on a rear surface thereof to be slidably coupled to the rail portions (111) of the vertical guide (10), and protrusion lines (24) formed on both side surfaces thereof to be slidably coupled to the guide grooves (121) of the vertical guide (10).

5. The vertical planter assembly according to claim 1, wherein the cultivation housing (20) is open at a top portion and the front surface thereof and further includes an eave part (27) inclined upward at the open front surface, and
wherein the cover part (30) includes: a first cover plate (31) coupled to the open front surface of the cultivation housing (20), and a second cover plate (32) bent downward and inclined from the first cover plate (31) so as to cover the eave part (27), wherein the first cover plate (31) includes a mounting hole (311) in which the planter pot (40) is mounted and a plurality of guide bars (312) configured to guide the planter pot (40) at an inclination angle.

6. The vertical planter assembly according to claim 5, wherein the cultivation housing (20) further includes a nonwoven fabric

(29) fixed in a hanging state at a lower front portion thereof, and
wherein the nonwoven fabric (29) extends to the bottom surface of the cultivation housing (20) arranged below and absorbs moisture by the capillary action to continuously supply the moisture to roots of a plant planted in the planter pot (40) of the cultivation housing (20) arranged below.

7. The vertical planter assembly according to claim 5, wherein the first cover plate (31) of the cover part (30) is one of a trapezoidal shape with an expanded lower width or a rectangular shape.

8. The vertical planter assembly according to claim 1, wherein the vertical guide (10) further includes a circular connection band (50) configured to interconnect the vertical guides (10) arranged in parallel to be arranged independently in a concentric structure.
